(19) United States
(12) Patent Application Publication
(10) Pub. No.: US 2014/0054961 A1
(43) Pub. Date: Feb. 27, 2014

(54) WIRELESSLY POWERED FURNITURE

(71) Applicants: Keith E. Metcalf, Jasper, IN (US); Jay M. Henriott, Jasper, IN (US)

(72) Inventors: Keith E. Metcalf, Jasper, IN (US); Jay M. Henriott, Jasper, IN (US)

(73) Assignee: Kimball International, Inc., Jasper, IN (US)

(21) Appl. No.: 14/000,798

(22) PCT Filed: Mar. 2, 2012
(86) PCT No.: PCT/US12/27360

§ 371 Date: Oct. 30, 2013

Related U.S. Application Data
(60) Provisional application No. 61/448,698, filed on Mar. 3, 2011.

(51) Int. Cl. H02J 17/00

(52) U.S. Cl. CPC H02J 17/00
USPC 307/19

(57) ABSTRACT

A remote transmitter wirelessly transmits energy to an article of furniture adapted to receive and store the wireless energy. The article of furniture is further adapted distribute the stored energy to electrical loads such as peripheral electronic devices, portable electronic devices and other articles of furniture. The remote transmitter may wirelessly transfer energy during inactive periods. The stored energy may be distributed to an electrical loads during an active period.

### CROSS-REFERENCE TO RELATED APPLICATIONS

This application claims the benefit of priority from U.S. Provisional Patent Application Ser. No. 61/448,698 entitled WIRELESSLY POWERED FURNITURE filed on Mar. 3, 2011, the disclosure of which is expressly incorporated by reference herein in its entirety.

### FIELD OF THE DISCLOSURE

The present disclosure relates generally to wirelessly powered furniture components. More particularly, the present disclosure relates to furniture components comprising electronic devices for wirelessly receiving power and transferring the received power to peripheral electronic devices and other furniture components.

### BACKGROUND OF THE DISCLOSURE

Office furniture components, such as desks and partition systems, typically include power outlets, and their associated cabling and power in-feed mechanisms, built into the components. A wired connection is established between an alternating current (AC) power source and an electronic device through a series of sockets, plugs and cables. This arrangement requires cables which limit the mobility of the furniture and require power outlets to be available in close proximity to the furniture to avoid stringing cable in open floor spaces.

The proliferation of peripheral electronic devices in office and home environments demands readily accessible sources of power. Peripheral electronic devices such as portable and mobile devices include phones, portable computers, music players, and personal digital assistants. Each electronic device requires a source of power which typically comprises an AC plug and a power converter to convert AC power to any of a plurality of direct current (DC) power levels. An unintended consequence of the proliferation of peripheral electronic devices is the proliferation of power converters, power sources, plugs and cables which clutter the office and home environments. Another unintended consequence is the loss of mobility of articles of furniture, such as tables, conference tables and the like, due to the tethering of power supply and distribution cables.

### SUMMARY OF THE DISCLOSURE

The present disclosure provides articles of furniture and furniture components that include electronic components that wirelessly receive power from transmitters spaced apart, or remote, from the furniture components and then distribute the power to electrical loads. Exemplary electrical loads include peripheral electronic devices, other furniture components and portable electronic devices. The electronic components may be referred to hereafter as a power distribution system. The furniture components may include energy storage devices. Charge controllers may activate the remote transmitters to charge the storage devices during inactive periods. The energy storage devices may then power the electrical loads during active periods. Furthermore, the furniture components may include input and output converters to transfer power to and from other furniture components such that one remote transmitter may power two or more furniture components. The articles of furniture may include housings received within work surfaces, the housings incorporating or housing the electronic components. The articles of furniture may also include the electronic components physically embedded or integrated within work surfaces in a manner in which the continuous surfaces of the work surfaces are maintained, and the work surfaces may optionally further include status indicators to indicate to users the status of the power distribution system.

In one embodiment according to the disclosure, a power distribution system for powering an electrical load is provided. The power distribution system comprises a wireless energy transmitter including a charge controller and a wireless energy source, the charge controller selectively causing the wireless energy source to transmit energy signals; and a first furniture component spaced apart from the wireless energy transmitter, the first furniture component having a work surface and including a wireless energy receiver receiving the energy signals, an energy storage device electrically coupled to the wireless energy receiver to receive energy therefrom, and a power output device adapted to transfer stored energy to an electrical load. In one variation of the present embodiment, the wireless energy source comprises a laser device and the energy signals comprise a laser beam. In one example thereof, the wireless energy receiver comprises a photovoltaic converter receiving the energy signals and providing electrical energy to the energy storage device. In another example, the power output device comprises one of a DC voltage output and a high voltage AC output. In a further example, the power output device comprises one of a micro-USB connector and a USB connector. In yet another example, the power output device comprises a primary coil of an inductive coupling. In yet a further example, the power output device comprises at least two conductive strips positioned parallel to the working surface of the furniture component. In another variation thereof, the working surface of the furniture component includes indicator devices configured to indicate a status of the power distribution system. Exemplary status indicators include charging, not charging, fully charged and fully discharged.

In another variation of the present embodiment, the wireless energy source comprises a laser device and the energy signals comprise a laser beam, the wireless energy receiver comprises a photovoltaic converter receiving the energy signals and outputting electrical energy having an first voltage, and the power distribution system further includes an energy storage device input converter configured to determine an energy storage device voltage and convert the first voltage to a second voltage based on the energy storage device voltage, the second voltage being higher than the energy storage device voltage, the energy storage device input converter providing electrical energy having the second voltage to the energy storage device. In one example, the photovoltaic converter is embedded in an edge molding of the furniture component. In another example, the photovoltaic converter is supported opposite the working surface of the furniture component and positioned to receive energy signals transmitted from a transmitter located in the floor.

In a further variation of the present embodiment, the power distribution system further includes an inactivity detector to determine an active period and an inactive period of a space in which the wireless energy transmitter is located, the charge controller selectively causing the wireless energy source to transmit energy signals during the inactive period and to not transmit energy signals during active period. In one example, the inactivity detector monitors a signal corresponding to at least one of a motion, a vibration and an illumination to determine the inactive period.

In another variation of the present embodiment, the power distribution system includes a second furniture component powered with at least a portion of the energy stored in the energy storage device of the first furniture component. In one example, the power distribution system further includes a second energy storage device supported by the second furniture component and receiving the at least a portion of the energy stored in the energy storage device of the first furniture component.

In another embodiment according to the disclosure, an article of furniture wirelessly coupled to a wireless energy transmitter is provided. The article of furniture is spaced apart from the wireless energy transmitter and comprises a furniture component having a working surface and a non-working surface opposite the working surface; a wireless energy receiver configured to receive energy signals transmitted by the wireless energy transmitter; an energy storage device electrically coupled to the wireless energy receiver to receive electrical energy therefrom; and a power output device adapted to transfer energy stored in the energy storage device to an electrical load. In one variation, the article of furniture further includes an inactivity detector configured to determine an activity status based on an activity signal and an activity signal threshold, the inactivity detector further configured to transmit an activity information to the wireless energy transmitter for preventing the transfer of energy signals based on the activity status. In another variation, the activity signal corresponds to at least one of a motion signal, a vibration signal and an illumination signal.

In a further variation of the present embodiment, the wireless energy transmitter comprises a laser device and the energy signals comprise a laser beam, the wireless energy receiver comprises a photovoltaic converter receiving the energy signals and providing electrical energy having an first voltage to the energy storage device, and the article of furniture further includes an energy storage device input converter configured to determine an energy storage device voltage and to convert the first voltage to a second voltage based on the energy storage device voltage, the second voltage being higher than the energy storage device voltage.

In an embodiment of a method according to the disclosure, a method of wirelessly powering an article of furniture is provided. In one variation thereof, the method is performed with the components of the article of furniture described in the previous embodiment. In another variation thereof, the method is performed with the components of the power distribution system described above. The method comprises positioning the article of furniture in a first position in a target space, the article of furniture including a wireless energy receiver and the target space including a wireless energy transmitter, wherein in the first position the wireless energy receiver is aligned to receive energy from the wireless energy transmitter; determining whether the target space is active or inactive; upon determining that the target space is inactive, transmitting wireless energy signals from the wireless energy transmitter to the wireless energy receiver; converting the wireless energy signals to electrical energy; charging an energy storage device supported by the article of furniture with the electrical energy; and transferring at least a portion of the electrical energy stored in the energy storage device to an electrical load.

In one variation of the present embodiment, determining that the target space is inactive comprises determining that a current time is within an off-peak period. In another variation, determining that the target space is inactive comprises detecting a signal indicative of activity in the target space and comparing the signal to an activity signal threshold. In a further variation, the method comprises sending an information signal to the wireless energy transmitter, the information signal including an inactivity indication. In yet another variation, the method includes sending an information signal to the wireless energy transmitter, the information signal including a charge data including an indication of a charge level of the energy storage device.

In another variation, the method of wirelessly powering an article of furniture comprises aligning a remote transmitter and an energy receiver to maximize a transfer of energy between them. In yet another variation, the method includes transferring electrical energy from the energy storage device to a second article of furniture. In another variation, the method includes the wireless energy receiver receiving the energy signals and outputting electrical energy having a first voltage, determining an energy storage device voltage, converting the electrical energy output by the wireless energy receiver to electrical energy having a second voltage based on the first voltage and the energy storage device voltage, the second voltage being higher than the energy storage device voltage.

The features of this invention, and the manner of attaining them, will become more apparent and the invention itself will be better understood by reference to the following description of the disclosed embodiments taken in conjunction with the accompanying drawings.

### BRIEF DESCRIPTION OF THE DRAWINGS

FIGS. 1 to 3 are perspective views of a plurality of furniture components wirelessly powered by a remote transmitter according to embodiments of the disclosure.

FIGS. 4 and 5 are block diagrams of power distribution systems including electronic components supported by the furniture components of FIGS. 1 to 3.

FIG. 6 is a sectional plan view of a housing for mounting the electronic components to the furniture components.

FIG. 7 is a flowchart of an embodiment according to the disclosure of a method for wirelessly powering furniture components.

FIG. 8 is a perspective view of a furniture component wirelessly powered by a remote transmitter according to a further embodiment of the disclosure.

FIG. 9 is schematic bottom view of the embodiment of the furniture component described with reference to FIG. 8

FIGS. 10 and 11 are perspective views embodiments according to the disclosure of components of a power distribution system described with reference to FIG. 8.

FIGS. 12 to 16 are representations of embodiments according to the disclosure of components of another power distribution system.

FIGS. 17 to 19 are further embodiments according to the disclosure of components of power distributions system incorporated into furniture components.

Corresponding reference characters indicate corresponding parts throughout the several views. Although the drawings represent embodiments of the present disclosure, the drawings are not necessarily to scale and certain features may be exaggerated to better illustrate and explain the embodiments. The exemplifications set out herein illustrate embodiments of the disclosure in several forms and such exemplifications are not to be construed as limiting the scope of the invention in any manner.

### DETAILED DESCRIPTION

The present disclosure relates generally to articles of furniture such as desks, chairs, credenzas, etc. that are capable of powering and/or charging peripheral devices such as cell phones and computers, for example, without the need for a cord connection between an AC outlet and the furniture. The electrical energy from the AC outlet is first converted to a non-electrical form and sent across an open space by a transmitter. A receiver supported by the furniture receives the wireless energy which is converted back into electricity to power the peripheral device without the need for a wired connection between the transmitter and the receiver. It is contemplated that office furniture components, such as mobile tables, for example, will be disposed within a room and will include wireless receivers. The transmitter may include means for locating the receivers, such as by sending inquiry signals and receiving response signals from the receivers. When desired, the transmitter may selectively send energy to the receivers of the tables. In one example, wireless technology is combined with inductive or conductive power transfer technology in a wireless mobile furniture system in which tables include rechargeable energy storage devices and may include inductive or conductive modules embedded in the work surfaces for powering the peripheral devices.

Many articles of office furniture include work surfaces, which are typically horizontal work surfaces, such as desktops and table tops. Herein, these work surfaces will be described as including working surfaces and non-working surfaces. Working surfaces include surfaces exposed to users in the normal course of the use for which the furniture was intended, such as the top surfaces of desks and tables, armrests, and other suitable surfaces. Non-working surfaces include surfaces which are normally not exposed to users such as the opposite sides of the top surfaces, i.e., the undersurfaces of the top surfaces, as well as hidden surfaces and the like.

As used herein wireless technologies are those in which energy is transferred through air. Electromagnetic (EM) and acoustic technologies are exemplary wireless energy transmission technologies. In EM technology, a source generates an EM signal which is received by a receiver circuit. Energy is absorbed from the signal by the receiver circuit and converted to electrical power. Exemplary EM technologies include radio frequency (RF), infrared and visible light, and induction. RF energy can be transferred over a distance of several feet although the RF signal degrades rapidly as the distance from the source increases. Acoustic energy is similar to RF energy in that energy propagates multi-directionally. Traditional induction technology is only effective over short distances, in the order of fractions of an inch to a few inches. Magnetic resonant induction technology is capable of transmitting energy over longer distances than traditional induction technology. The energy transfers can be maximized by establishing communications between the energy source and the energy receiver to calibrate the source and/or the receiver to each other.

In one embodiment according to the disclosure, a wireless power receiver, a energy storage device and a power output adapter are supported by a furniture component. Exemplary energy storage devices include batteries and capacitors. The wireless power receiver wirelessly receives power, converts the received power to electrical energy, and outputs the electrical energy to an input converter. Exemplary wireless power receivers include photovoltaic cells, photovoltaic diodes, RF receivers and acoustic receivers. The electrical energy is input converted by the input converter to a form suitable to charge the energy storage device, and the input converted energy is received and stored by the energy storage device. An exemplary input converter comprises a circuit arrangement configured to increase a first voltage of the electrical energy to a second voltage higher than a present voltage of the energy storage device. In one example, the circuit arrangement comprises a pulse-width-modulated booster having a voltage conversion ratio variably adapted according to a charging algorithm to trickle-charge the energy storage device. The stored energy is output converted by an output converter to a form suitable for a load device, and the output converted energy is received by the load device. An exemplary output converter comprises a circuit arrangement configured to increase or decrease the voltage of the present voltage level of the energy storage device to a level suitable for an output voltage connector and, if desired, to change the form of the energy from direct (DC) to alternating current (AC). Exemplary output voltages include 5 volts DC (suitable for USB connectors), 12 volts DC (suitable for devices such as portable computers) and 120 volts AC (suitable for devices such as AC/DC converters), which is considered a high voltage relative to the USB voltage. In one example, the circuit arrangement comprises a pulse-width-modulated (PWM) buck/boost converter having a voltage conversion ratio variably adapted to provide a fixed output voltage level even as the voltage of the energy storage device varies. In another example, the circuit arrangement comprises a push-pull PWM converter having a voltage conversion ratio variably adapted to provide a constant AC output voltage level even as the voltage of the energy storage device varies. The input and output circuit arrangements may also include diode bridge rectifiers, rectifying capacitors and inductors, current limiting circuits, fuses and other electronic components configured to protect the circuit arrangement from damaging over and under-loads. In one variation of the present embodiment, the wireless receiver is integrated with the input converter. In another variation of the present embodiment, the input converter is integrated with the output converter and includes contacts for coupling the wireless receiver, the energy storage device, and at least one output connector. An exemplary converter is discussed with reference to FIG. 13.

In another embodiment according to the disclosure, the wireless transmitter is configured to transmit energy during inactive periods and not during active periods. In one example, active periods comprise daytime periods and inactive periods comprise nighttime periods. Energy is transferred during inactive periods and stored in the rechargeable energy storage device. During active periods, stored energy provided to load devices depletes the stored energy. This method may be particularly advantageous when inactive periods include “off peak” hours when electrical rates are low compared to peak hours. In one example, furniture components can be moved and reconfigured about a room for use during active periods without regard to the location of the wireless transmitter and without any need for a wire-based connection anywhere in the room. During inactive periods, the furniture components are placed within reach of the wireless transmitter, and the wireless energy distribution system wirelessly recharges the energy storage devices in the furniture components. Of course, the wireless energy transfer system may be also used during active periods as required, for example if the energy storage devices become sufficiently depleted. Safety mechanisms may be provided to protect users when wireless energy transfers occur during active periods. Exemplary safety mechanisms include beam orientation, beam interruption detection, nearby motion sensing, and the like. Additionally, inductive or conductive modules may be supported by the furniture components to transfer energy wirelessly between the furniture components.

More generally, in various embodiments described below, multiple energy transfers take place. In a first transfer, a remote source transfers energy to a receiver in a furniture component which may be referred to as a master furniture component. The energy is stored and, in a second transfer, the energy is distributed to an electrical load such as a portable electronic device. The energy may also be distributed to another load such as a furniture component located proximally the master furniture component, which may be referred to as a slave furniture component. Thus, furniture components may include energy receivers for receiving remotely transmitted energy and also proximally provided energy. Proximal transmitters and receivers may be referred to herein as power adapters to be distinguished from remote energy transmitters and receivers. In addition to wireless power transfers, power adapters may transfer energy by direct connection. Furniture supported electronic components, including power adapters and power transfer surfaces, may be supported, embedded or integrated into furniture components in any number of ways including using electronics housings. Exemplary housings for supporting and embedding power adapters and for indicating their presence to a user are described in commonly owned U.S. Pat. No. 8,061,864, entitled “Furniture with Wireless Power” which is incorporated in its entirety herein by reference. Alignment and communication features may also be included for safety and to maximize remote power transfer rates.

In induction technology, a source, or primary, coil generates a magnetic field which induces current in a second, or secondary, coil. The area in which inductive energy may be received, referred to as a “hot-spot,” is fairly localized about the primary coil. Typically, in the embodiments disclosed herein, the primary coil will be integrated into an article of furniture. A wireless device including the secondary coil may receive power from the primary coil by induction of electrical current in the secondary coil when the secondary coil is brought into proximity with the primary coil. The current generated in the secondary coil may be used to power the electronic device or charge energy storage device in the electronic device. An induction controller produces a signal to power the primary coil at a modulated frequency. Information may be transferred by the signal to the secondary coil and then extracted by the electronic device being charged. The electronic device may include inactive circuits and/or wireless communication circuits to transmit information back to the controller, thus establishing hand-shakes or hand-shaking which the controller may use to modulate the signal.

In conduction technology, a surface of an article of furniture with at least one pair of positive/negative contacts, which are exemplified by elongate, conductive contact pads or strips, transfers energy to receiving contacts on an electronic device which, when the electronic device is placed on the pads, completes an electrical circuit between the pads. The receiver may be positioned in a plurality of orientations without causing a short-circuit. The pads are typically flat elongate rectangular-shaped plates disposed in parallel and sufficiently spaced apart so that contacts do not bridge adjacent pads. The polarity of each pad may be selected by a conduction controller based in part on feedback from the contacts. Conduction controllers typically include voltage and current regulators and features designed to protect the electronic devices and the controllers.

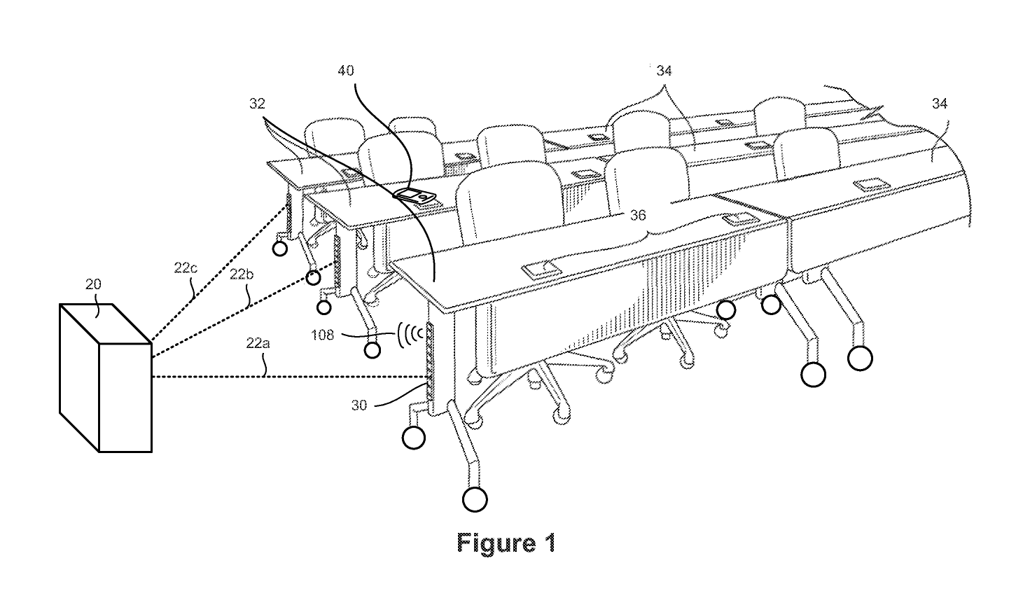

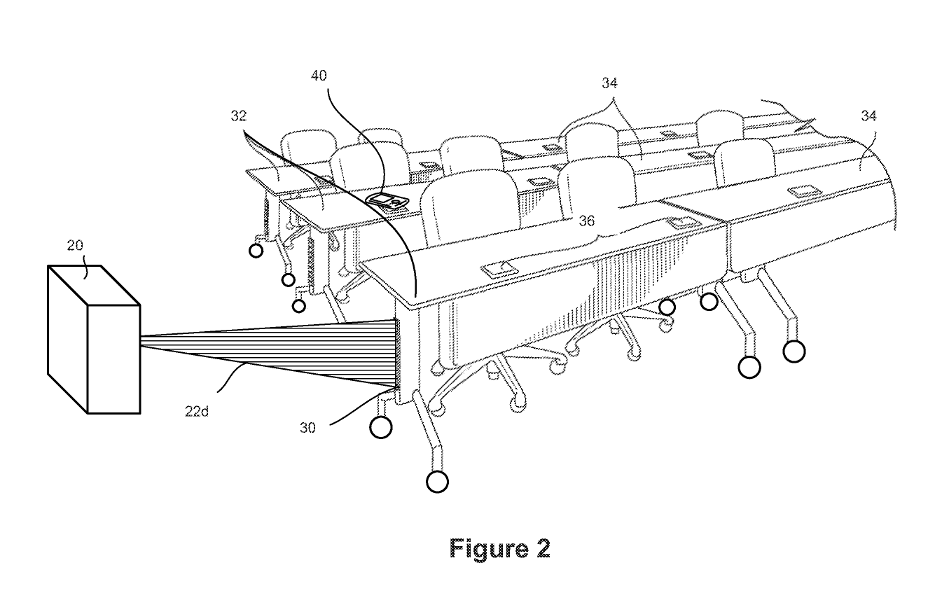

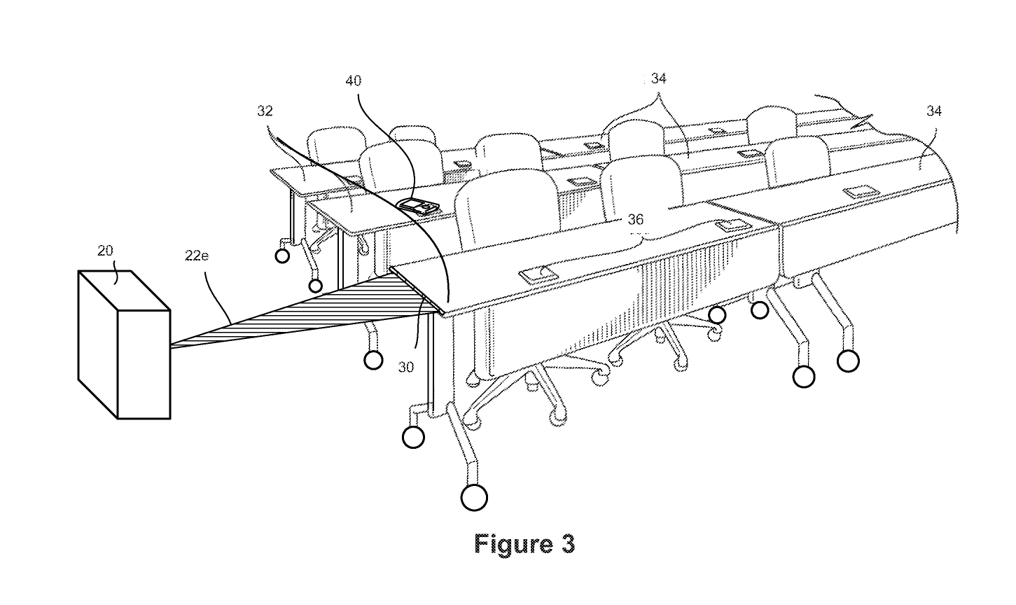

The above description of exemplary embodiments will now be described with reference to the figures. FIGS. 1 to 3 are perspective views of a plurality of master furniture components 32 and slave furniture components 34 wirelessly powered by a remote transmitter 20. Transmitter 20 may transmit energy signals of varying characteristics. Exemplary characteristics are described below with reference to energy signals 22a-22e. Referring to FIG. 1, furniture components 32 include energy receivers 30 receiving energy signals 22a, 22b and 22c transmitted by remote transmitter 20. Receiver 30 includes an energy receiving surface which may have any shape. For example the energy receiving surface may be circular, rectangular, square, concave, convex or may have any other shape. Receiver 30 is shown having a rectangular shape conforming to an edge trim of the furniture component. In one example, the energy source is a laser and energy signals 22a, 22b and 22c are laser beams. An exemplary power beaming system is available from PowerBeam Inc., Mountain View, Calif., U.S.A., which may deliver 10 watts of power from a distance of less than 1 meter up to 30 meters. Power beaming systems are also described in U.S. Pat. Publications Nos. 2007/0019693, 2008/0084596 and 2008/0130124, assigned to PowerBeam Inc., and 2010/0078995, 2010/0079005 and 2010/0079008, assigned to Searete LLC, Bellevue, Wash., U.S.A. The foregoing publications are incorporated in their entirety herein by reference. A laser beam may be point-focused so that energy signal 22a, 22b, 22c is a pencil beam. In one variation, the laser scans to emit, in sequence, energy signal 22a then 22b then 22c in a repeating cycle. In another variation, a beam splitter is provided to emit energy signals 22a, 22b and 22c concurrently. The beam may also be diffracted to emit energy along a plane as illustrated by energy signals 22d in FIGS. 2 and 22e in FIG. 3. In a further variation, remote transmitter 20 scans the pencil beam along the length of one receiver 30 and then scans along the length of another until all receivers 30 have been scanned, and then the cycle repeats. Also shown are power transfer surfaces 36 which are electrically coupled to receive energy received by receiver 30 and to transfer the energy to a peripheral device 40. In other embodiments, wirelessly received energy may be transferred to peripheral device 40 with a wired connection or by induction, for example.

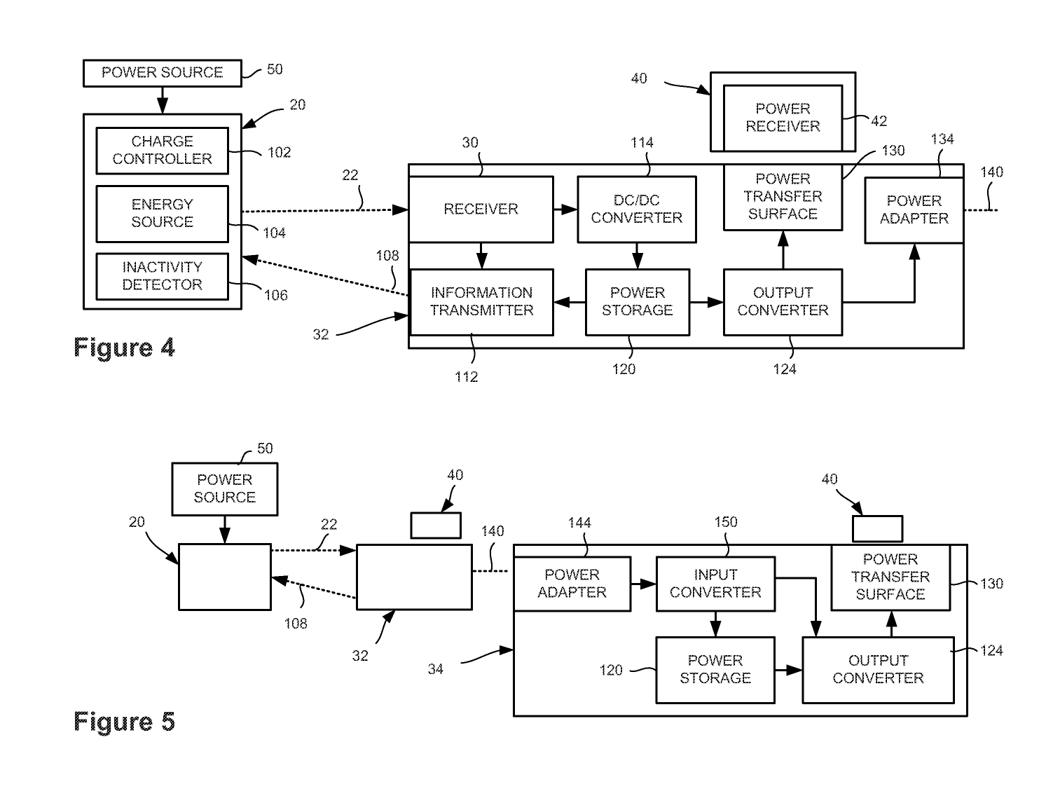

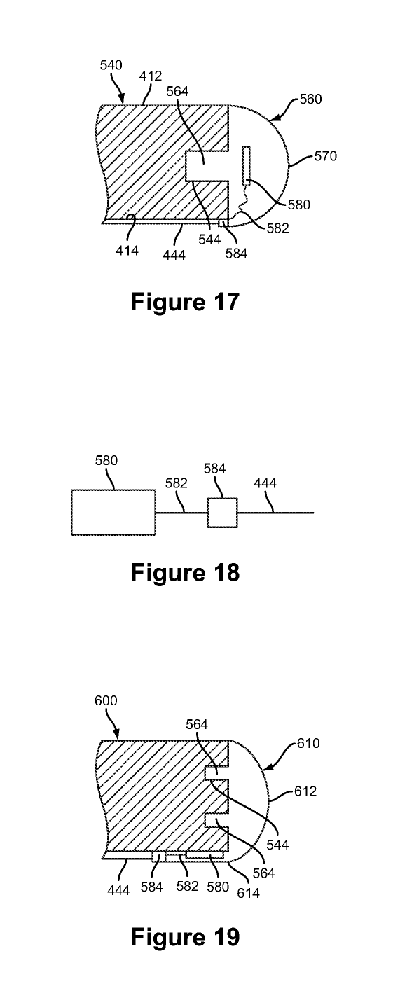

In a further variation, an information signal 108 is sent by furniture component 32 to remote transmitter 20. In one example, the information signal indicates to remote transmitter 20 the charge state of an energy storage device 120 (shown in FIGS. 4 and 5). In another example, the information signal indicates to remote transmitter 20 that a charge is being received and/or the amount of charge received. In one variation, remote transmitter 20 scans the room in which furniture components 32 are located and identifies the location and size of receivers 30 based on the charge feedback information contained in the information signal. Remote transmitter 20 may then adjust the diameter of the pencil beam or the width of the plane of the energy signals to spread the energy footprint and reduce heating generated by the conversion of energy into electrical energy. For example, if receiver 30 includes a photovoltaic cell, it is advantageous to distribute the energy throughout the surface of the cell rather than focus it on a point on its surface. Furniture component 32 may also include a diffraction device which enables it to receive a pencil beam and spread the received energy through the surface of the cell. In one example, the diffraction device comprises a convexly shaped edge molding of a furniture component. Exemplary concavely shaped edge moldings are discussed with reference to FIGS. 17 and 19.

In various embodiments herein, one or both of remote transmitter 20 and receiver 30 include mono or biaxial alignment systems to align the energy signals with the energy receiving surface of receiver 30 and thereby maximize the energy transfer rate. The remote transmitter includes a device which converts electrical energy into wireless energy and which is referred to herein as the remote transmitter's energy source. If the energy source is positioned to transmit at a known height relative to the receiving surface, the transmitting device may only need a monoaxial alignment system. The energy source has an origin in an arbitrary coordinate space. The alignment system may translate the energy source in three dimensions (vertically, horizontally and forwards/backwards) and may also orient the energy source in three orientations, thereby achieving six degrees of freedom relative to the origin. Translation and orientation may also be relative to diffraction devices to shape the energy signal therewith. For example, the diameter of the pencil beam may be changed or its focal point brought closer or further away from the origin to distribute or focus the transferred energy at various points along the receiving surface. In other variations, remote transmitter 20 has multiple energy sources and/or beam splitters, prisms, diffractors and other beam effecting devices to individually position (location and orientation) and simultaneously transmit multiple beams. When energy is radiated, remote transmitter 20 may include multiple antennas and features adapted to modify the radiation frequency.

Referring to FIGS. 4 and 5, block diagrams of an embodiment according to the disclosure of a wireless power distribution system are provided. A power source 50, for example a wall receptacle, powers remote transmitter 20 which includes a charge controller 102, an energy source 104 and an inactivity detector 106. In one variation, receiver 30 also functions as inactivity detector 106, for example by detecting a low light condition in the room in which the furniture is disposed. In another variation, inactivity detector 106 comprises a vibration sensor (not shown) coupled to any of the electronic components supported by furniture components 32 and 34 to detect movement and/or use. Exemplary vibration sensors include strain gages and inertial sensors such as accelerometers and gyroscopes. In one example, charge controller 102 includes an information signal receiver (not shown) receiving information signal 108 transmitted by an information transmitter 112. In yet another variation, inactivity detector 106 comprises a security system which provides an inactivity indication when it determines the absence of individuals within the space or, more specifically, when all individuals that entered the target space also exited the target space. Exemplary security system include card or biometric scanning systems, mass scanning systems, and other suitable systems to detect entry and exit of individuals from a target space.

Information signal 108 may include a charge feedback indication and an inactivity indication. For example, if receiver 30 is a photovoltaic cell, darkness in the room may be predefined as an indication of inactivity, and voltage produced by receiver 30 below a voltage threshold may indicate such inactivity. The information signal may communicate the inactivity indication or may communicate the voltage produced by receiver 30 in which case inactivity detector 106 in remote transmitter 20 may determine an inactivity status based on the voltage. Furthermore, inactivity detector 106 in remote transmitter 20 may pool feedback signals from all receivers 30 before determining inactivity. Charge controller 102 permits transmission of energy signals by energy source 104 upon the determination of inactivity. Charge controller 102 may also control the alignment systems, transmission rates, scanning and other power optimization features of the wireless transmission system. In a further embodiment, system components are predetermined and charge controller 102 is programmed with operational parameters such as receiver positional information, beam patterns, power levels and scanning or cycling information. Charge controller 102 then self-configures to generate the appropriate energy signals. In yet another embodiment, sets of operational parameters are programmed in remote transmitter 20. Upon receipt of identification codes from information transmitter 112, remote transmitter 20 is able to configure energy source 104 to match the configuration of the particular receiver 30 associated each identification code.

In addition to receiver 30 and information transmitter 112, furniture component 32 may comprise additional electronic components to store and distribute energy received from energy signal 22. Shown in FIG. 4 are a DC/DC converter 114, an energy storage device 120, an output converter 124, a power transfer surface 130 and a power adapter 134 producing a power signal 140. DC/DC converter 114 may comprise a buck/boost converter to cause receiver 30 to operate at its maximum power point. DC/DC converter 114 may also incorporate control features to manage the load. In one example, energy storage device 120 is a battery and DC/DC converter 114 changes its output depending on the amount of charge present in the battery. As the charge increases, DC/DC converter 114 reduces the energy transfer to a trickle-charge level. In other examples, energy storage device 114 is a fuel cell or a capacitor.

Stored energy is transferred to one or both power transfer surface 130 and power adapter 134. Power transfer surface 130 may comprise a primary inductive coil, conductive strips, an RF transmitter or a wired connector depending on the technology chosen to power peripheral device 40. Output converter 124 converts energy stored in energy storage device 120 and converts it to an appropriate form. For inductive technology, output converter 124 converts stored energy into alternating current. For conductive technology, output converter 124 converts stored energy into direct current of a level appropriate for peripheral device 40 and switches power to appropriate conductive strips on the surface of power transfer surface 130. Peripheral device 40 comprises a power receiver 42 suitable for coupling with power transfer surface 130. Power adapter 134 is similar to power transfer surface 130 except that it is adapted to transfer energy through signal 140 to slave furniture component 34 as shown in FIG. 5.

Referring to FIG. 5, slave furniture component 34 may comprise additional electronic components to store and distribute energy received from master furniture component 32 to facilitate distribution of energy received from energy source 104. As shown in FIG. 5, a power adapter 144 receives energy from power adapter 134 through signal 140. Signal 140 can be an inductive coupling signal, a conductive signal, an RF transfer signal and can also be electricity passing through a connection between mating connectors. Input converter 150 converts the power from power adapter 144 into a suitable form to be received by energy storage device 120 or output converter 124. While the electronic components are described independently according to their function, one or more of the electronic components can be integrated to simplify the system. In one variation, all the electronic components coupled to receiver 30 are housed together but separately from receiver 30. In another variation, all the electronic components coupled to receiver 30, except power adapter 134, are housed together and separately from receiver 30.

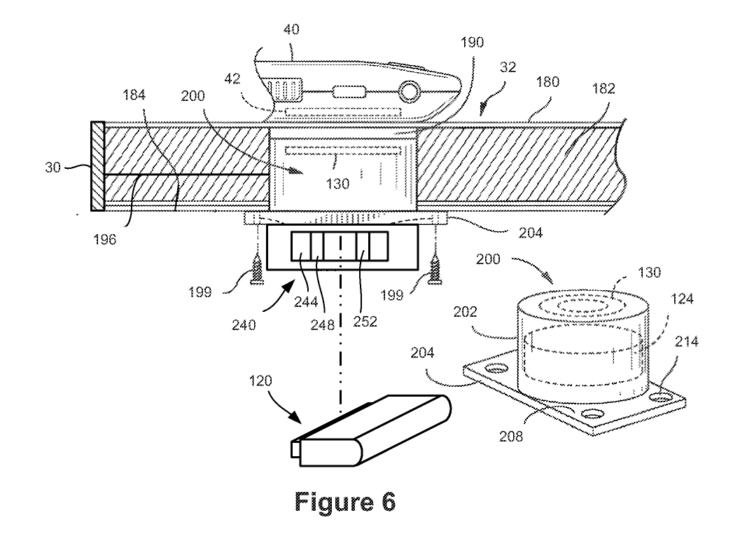

Referring to FIG. 6, a cross-sectional view of furniture component 32 is shown. In the present embodiment, furniture component 32 comprises receiver 30 which is coupled by an electrical conductor 196 to electronic components including output converter 124 in a housing 200 embedded in a cavity 190 provided in an intermediate portion 182 between a working surface 180 and a non-working surface 184 of furniture component 32. Housing 200 comprises a housing wall 202 extending from a surface 208 of a flange 204 having openings 214 provided to secure housing 200 to furniture component 32 with securement devices 199. Securement devices 199 may comprise nails, screws, staples, adhesives and any other securement devices. Screws are shown. Additional housings, or grommets, supporting electrical components, illumination devices and power transfer surfaces are disclosed in commonly owned U.S. Pat. No. 8,061,864, entitled “Furniture with Wireless Power” which is incorporated by reference.

Additionally, a housing 240 is shown affixed to housing 200 and including a cavity 244 adapted to receive energy storage device 120. As shown, energy storage device 120 is a removable battery. Contacts 248 and 252 electrically couple output converter 124 to energy storage device 120. As shown in FIG. 6, power transfer surface 130 and power receiver 42 include primary and secondary coils which are inductively coupled when energized to transfer energy to peripheral device 40. Alternatively, power transfer surface 130 and power receiver 42 can include conductive strips and connectors to establish a conductive coupling. Cavity 190 may extend from nonworking surface 184 through to working surface 180 to enable a conductive surface supported by housing 200 to be accessible to a user. In another example, power transfer surface 130 and power receiver 42 comprise transmitting and receiving antennas. The transmitting antenna may be provided on the working surface of furniture component 32 rather than inside housing 200. The electronic components in furniture component 34 may be secured in a similar manner. Power adapter 134 and 144 may establish an inductive coupling or a conductive coupling, for example. Power adapter 134 and 144 may also be wiredly coupled with a plug and a receptacle. The electronic components may be distributed in multiple cavities in the furniture component or within multiple housings secured to non-working surfaces. In one variation, housings 200 and 240 are spaced apart from each other. Housing 240 may be positioned proximally to receiver 30. In one embodiment, receiver 30, energy storage device 120, and information transmitter 112 are housed together and separately from a power transfer device powering peripheral device 40. In one example, the power transfer device includes power transfer surface 130 and output converter 124.

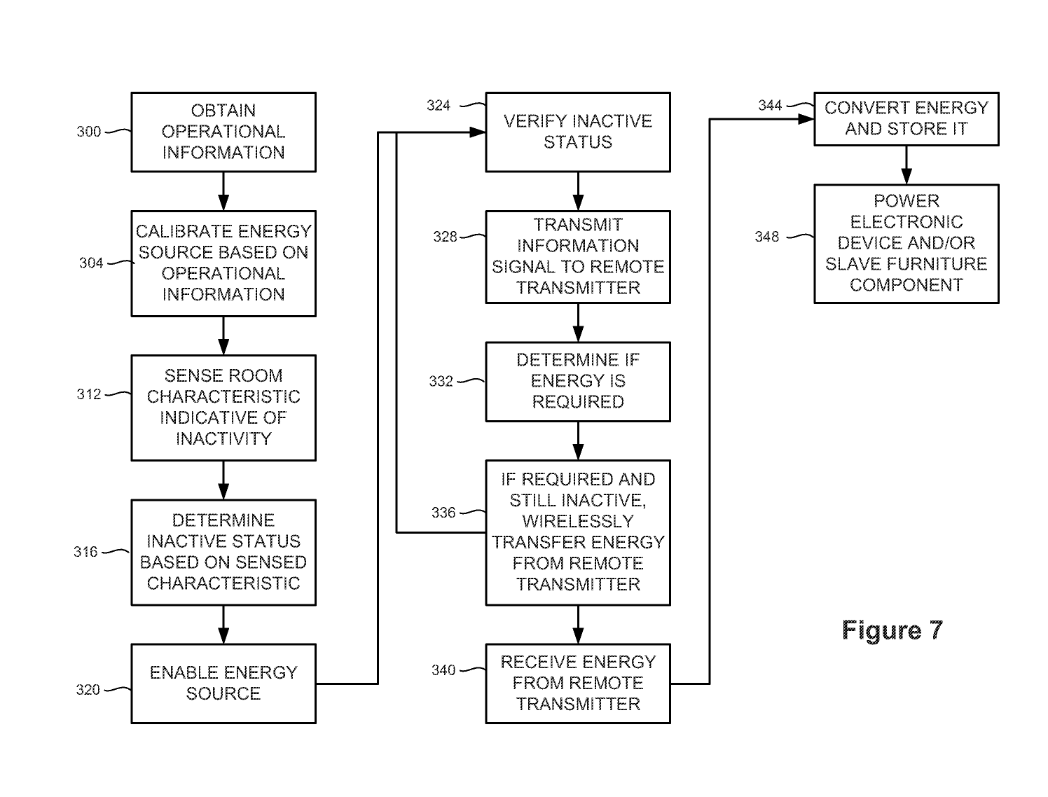

A flowchart of an embodiment according to the disclosure of a method for wirelessly power furniture components is shown in FIG. 7. According to the method, at box 300 operational information is obtained. Operational information can be pre-programmed in the remote transmitter or can be obtained by the remote transmitter by scanning the space in which the remote transmitter is located. Exemplary target spaces include rooms, offices and hallways. The remote transmitter can also receive operational information from master furniture components. Based on the information, at box 304 the remote transmitter calibrates the energy source. Calibration may entail alignment of the energy source with the energy receivers and definition of the energy signals, for example. Target space characteristics indicative of inactivity are sensed at box 312 and at box 316 an inactive status is determined based on the sensed characteristics. The remote transmitter or the furniture components may sense the characteristics. Inactivity indicia may be determined by the furniture component and transmitted with the information signal as described with reference to FIGS. 4 and 5. If the room is inactive, at box 320 the energy source may be enabled to transmit energy. The inactive status of the target space is verified continuously or substantially continuously at box 324. If the status changes, further energy transfers are disabled. At box 328 the information signal is transmitted and, based on the information signal, at box 332 the remote transmitter determines if energy is required. In another variation, the furniture component determines if energy is required and the information signal includes a power requirement indicia indicating to the remote transmitter that power is required. At box 336, so long as power is required and the target space is inactive, the remote transmitter transfers energy. At box 340 the master furniture component receives energy and at 344 the energy is stored. If enough energy is available, energy is then transferred at box 348 to power electronic devices or slave furniture components.

A furniture component including a wireless power system as described above may include indicator devices to indicate a status of the energy storage device. Exemplary status indications include charged, charging, not charging, fully discharged and defective. The absence of an indication may indicate misalignment between the transmitter and the receiver. Alternatively, a not charging status may be indicated using power drawing from the energy storage device. In one example, housings embedded in furniture components include illumination devices. Exemplary illumination devices include light-emitting-diodes (LEDs), incandescent lights and fluorescent lights. In one example, illumination devices are inlaid in the working surface of the furniture component. In a variation thereof, illumination devices are inlaid in the edge surface of the furniture component. In a further example, illumination devices are housed in a housing made of translucent material, e.g., a transparent polymer, and the housing is embedded in the furniture component. In one variation, the illumination devices are coupled to the input converter, which is configured to power the illumination devices. In the present variation, the input converter is configured to determine the status and to indicate the status by powering the illumination devices accordingly. For example, the illumination devices may be dimmed at a level corresponding to the charge level of the energy storage device, may be flashed at different rates to indicate the charge level, and may be flashed in different on/off sequences to indicate different statuses. In one example, the input converter further comprises decoupling devices activated by the input converter to electrically decouple the output converter from the energy storage device when the energy storage device is being charged, thereby preventing simultaneous coupling of the energy storage device to power input and output circuits. Exemplary decoupling devices include relay contacts and transistors.

It may be desirable to not interrupt the aesthetics of the working surface of the furniture component. The working surface may comprise a polyurethane protective coating or an ultraviolet (UV) coating. The working surface may also comprise a decorative veneer. In one example, a housing positioned within a cavity formed in the non-working surface of a furniture component includes indicator devices. In the present example, the furniture component comprises a thermoplastic material, e.g. acrylic, polypropylene, and the like, configured to permit light to pass therethrough. Thermoplastic materials may be transparent and may comprise particulate matter which may or may not be transparent. An exemplary embodiment of a suitable thermoplastic material is CORIAN™ which is distributed by DuPont, Inc. CORIAN™ comprises an acrylic polymer and alumina trihydrate. Another suitable material is named GIBRALTAR™ and is distributed by Wilson-Art, Inc.

In a further exemplary embodiment, illumination blocks are provided with holes to generate directional illumination effects. The illumination blocks are positioned within a cavity in furniture component. The illumination block projects light through the holes. Exemplary holes are made perpendicularly to the working surface of the furniture component or at a slanted angle thereto. Through-holes may be filled with translucent materials including tinted and colored polymers and glass to generate additional illumination effects. Additional indicators and indication methods are described in commonly owned U.S. Patent Publication No. 2010/0290215 entitled “Furniture with Wireless Power” which is incorporated in its entirety herein by reference thereto.

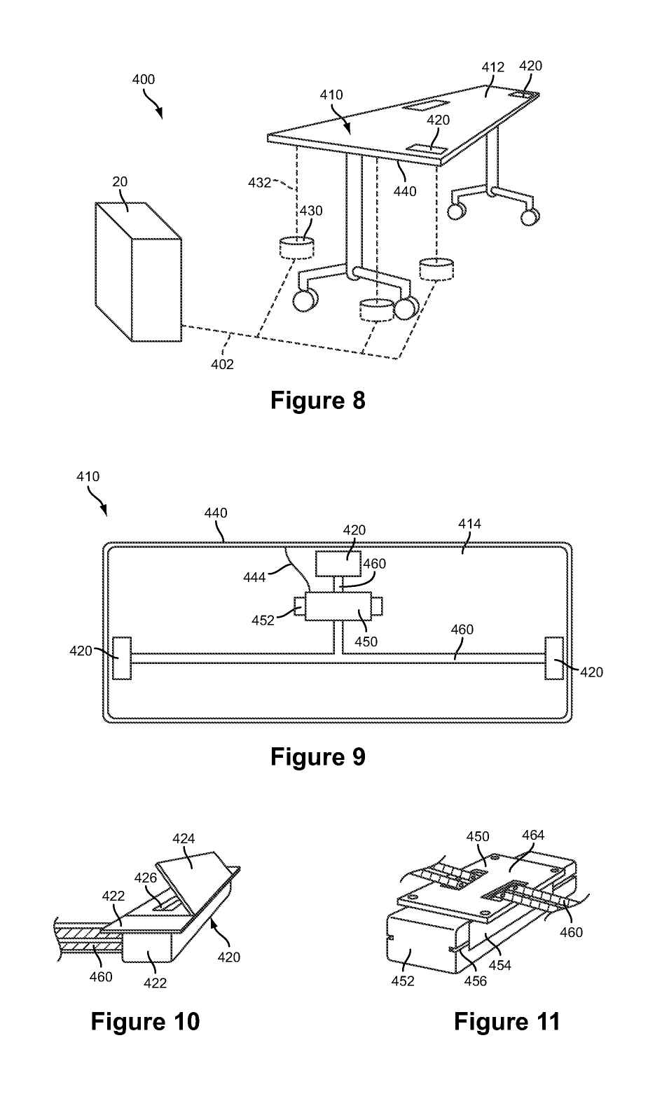

Referring now to FIGS. 8 and 9, a perspective view of a wireless power distribution system according to a further embodiment of the disclosure is provided. The wireless power distribution system, illustratively system 400, includes a furniture component wirelessly powered by a remote wireless power transmitter The furniture component, illustratively furniture component 410, includes a working surface 412 opposite a non-working surface 414. Available through working surface 412 are a plurality of power output housings 420. An edge mold 440 is provided on the peripheral surface of furniture component 410. Embedded in edge mold 440 is a wireless energy receiver (not shown) adapted to receive wireless energy signals 432 transmitted from a plurality of transmitter elements 430. Exemplary edge molds are discussed with reference to FIGS. 17 and 19. In one example, a transmitter element 430 comprises fiberoptic light guides coupled to remote transmitter 20. Remote transmitter 20 provides energy which is transmitted through light guides 402 to transmitter elements 430. As the transmitter elements project light beams up towards non-working surface 414 of furniture component 410, beams 432 intersect the wireless energy receivers thereby transmitting energy wirelessly to furniture component 410. An exemplary schematic diagram illustrating the electrical component connections is provided in FIG. 9.

Referring to FIG. 9, a plurality of conductors, illustratively flat-wire 460, electrically couple power output housings 420 with an energy storage device 452 supported by an energy storage device housing 450. A conductor 444 couples the wireless energy receiver embedded in edge mold 440 with energy storage device 452. Input and output energy storage device converters may also be provided to compatibilize the voltage of the wireless energy receiver with the voltage of the energy storage device and an output adapter supplied by the energy storage device or the output energy storage device converter.

FIGS. 10 and 11 are perspective views of components of a wireless power distribution system. Power output housing 420 includes lateral walls 422, a working surface wall 422, a lid 424 and an output power connector 426. Connected to output power connector 426 is flat wire 460. Although flat wire is suitable in the present application due to its inobtrusive profile, any electrical conductor may be used to electrically couple the components. Power storage device housing 450 includes connectors adapted to couple with flat wire 460, a first surface 464 to be parallel to non-working surface 414 when power storage device housing 450 is mounted to non-working surface 414 and a lateral wall 454 perpendicular to first surface 464. Energy storage device 452 includes opposing slots 456 engaging protrusions 468 (shown in FIG. 13) extending from walls 454 and provided to retain energy storage device 452 slidingly engaged with power storage device housing 450.

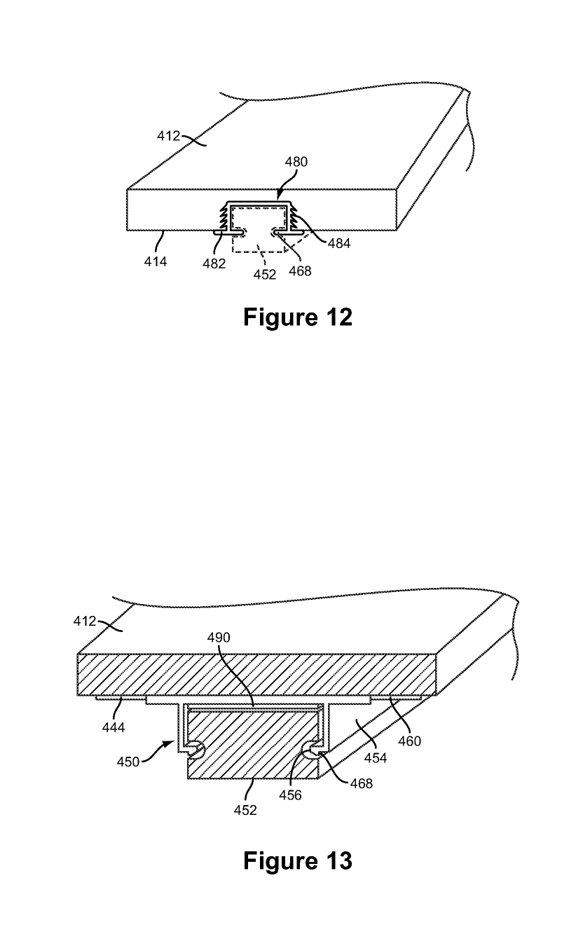

FIG. 12 illustrates another embodiment of an energy storage device housing, illustratively energy storage device housing 480. Energy storage device housing 480 is embedded in a table top of a furniture component. Shown in phantom is energy storage device 452. Energy storage device housing 480 includes a plurality of protrusions 484 adapted to secure energy storage device housing 480 in a slot provided in the underside of the table top. Edge walls 482 extend parallel to non-working surface 414.

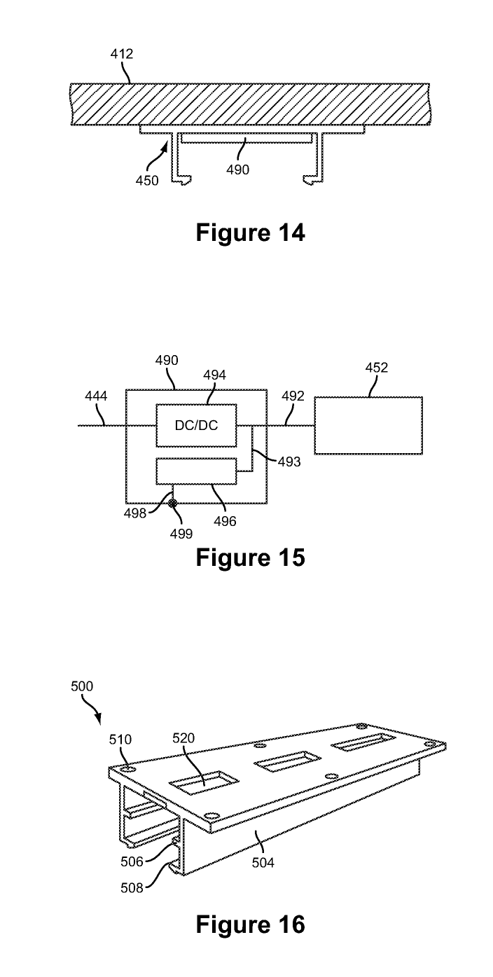

Referring to FIGS. 13 to 15, perspective, plan and schematic views of power storage device housing 450 and energy storage device 452 are provided. Also shown is a power converter 490 coupled to conductor 444 and flat wire 460. A schematic diagram of power converter 490 is shown in FIG. 15. Power converter 490 includes an energy storage device input converter 494 coupled by a conductor 492 to energy storage device 452 and by a conductor 493 to an energy storage device output converter 496. Energy storage device output converter 496 is also coupled electrically by a conductor 498 to an output contact 499 adapted to distribute electrical energy to a load coupled thereto. Output contact 499 may be coupled, for example, to connector 426 shown in FIG. 10.

FIG. 16 is a perspective view of another embodiment of an energy storage device housing, illustratively energy storage device housing 500. Energy storage device housing 500 in similar to energy storage device housing 450 except that it includes, extending from a lateral wall 504, two protrusions or edge lips 506 and 508 adapted to removably secure an energy storage device. In one example, protrusion 508 supports the bottom surface of the energy storage device. In another example, protrusion 508 fits into a groove on a wall of the energy storage device in the same manner as protrusion 506 does (as illustrated in FIG. 13 with reference to protrusion 468). A plurality of apertures 510 are provided to secure energy storage device housing 500 to the non-working surface of a furniture component with securing members. Exemplary securing members include nails, screws and dowels. A plurality of apertures 520 are provided to enable passage of wires or electrical contacts therethrough to connect the energy storage device or power converter to conductors or flat wire disposed on the non-working surface to electrically connect the energy storage device to other electrical components.

Referring now to FIGS. 17 to 19, schematic and block diagram views of embodiments of a wireless power receiver 580 and edge guards or molds are provided. FIG. 17 illustrates an edge mold 560 comprising a protrusion 564 configured to be inserted into a slot 544 of a surface of a furniture component 540. A conductor 582 connects wireless power receiver 580 to conductor 444 with a connector 584 thereby enabling wireless power receiver 580 to transfer power to other electrical components as discussed with reference to FIG. 9, for example. As shown, edge mold 560 comprises a curved surface 570 configured to concentrate energy beams received by surface 570 unto wireless power receiver 580, whereby edge mold 560 functions as an elongate lens. In one example, edge mold 560 is formed of transparent polymers. Exemplary transparent polymers include acrylics, polyethylenes, block-copolymers and combinations thereof. Connector 584 may be provided on an external surface of edge mold 560 such that when edge mold protrusion 564 is embedded into slot 544 connector 584 is available for connection to conductor 444. FIG. 19 illustrates an edge mold 610 comprising protrusions 564 configured to be inserted into slots 544 and wireless power receiver 580 embedded in edge mold 610. Edge mold 610 has a surface 612 and another surface 614 facing towards the floor. Wireless power receiver 580 also faces the floor. In one example, edge guards or molds are be applied in continuous strips around the periphery of a furniture component. In another example, edge guards or molds are be applied in strips intermittently around the periphery of a furniture component. Wireless power receiver 580 may be embedded in the edge mold or positioned between the furniture component and the edge mold. The present embodiment is suitable for use in a power distribution system such as power distribution system 400 illustrated in FIG. 8.

The foregoing embodiments, variations thereof, and examples are not intended to limit the scope of the invention. In further embodiments, the power distribution system and the article of furniture include additional components suitable to execute the foregoing embodiments of a method of wirelessly powering an article of furniture. Additionally, in further embodiments of a method of wirelessly powering an article of furniture, the embodiments include steps inherent in the use of any of the components described with reference to the power distribution system and the article of furniture embodiments.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A power distribution system for powering an electrical load, the power distribution system comprising:
a wireless energy transmitter including a charge controller and a wireless energy source, the charge controller selectively causing the wireless energy source to transmit energy signals; and
a first furniture component spaced apart from the wireless energy transmitter, the first furniture component having a work surface and including a wireless energy receiver receiving the energy signals, an energy storage device electrically coupled to the wireless energy receiver to receive energy therefrom, and a power output device adapted to transfer stored energy to an electrical load.

2. A power distribution system as in claim 1, wherein the wireless energy source comprises a laser device and the energy signals comprise a laser beam.

3. A power distribution system as in claim 2, wherein the wireless energy receiver comprises a photovoltaic converter receiving the energy signals and providing electrical energy to the energy storage device.

4. A power distribution system as in claim 1, wherein the wireless energy source comprises a laser device and the energy signals comprise a laser beam, wherein the wireless energy receiver comprises a photovoltaic converter receiving the energy signals and outputting electrical energy having an first voltage, and wherein the power distribution system further includes an energy storage device input converter configured to determine an energy storage device voltage and convert the first voltage to a second voltage based on the energy storage device voltage, the second voltage being higher than the energy storage device voltage, the energy storage device input converter providing electrical energy having the second voltage to the energy storage device.

5. A power distribution system as in claim 1, further including an inactivity detector to determine an active period and an inactive period of a space in which the wireless energy transmitter is located, the charge controller selectively causing the wireless energy source to transmit energy signals during the inactive period and to not transmit energy signals during active period.

6. A power distribution system as in claim 5, wherein the inactivity detector monitors a signal corresponding to at least one of a motion level, a vibration level and an illumination level to determine the inactive period.

7. A power distribution system as in claim 1, further including a second furniture component powered with at least a portion of the energy stored in the energy storage device of the first furniture component.

8. A power distribution system as in claim 7, further including a second energy storage device supported by the second furniture component and receiving the at least a portion of the energy stored in the energy storage device of the first furniture component.

9. An article of furniture wirelessly coupled to a wireless energy transmitter which is spaced apart from the article of furniture, the article of furniture comprising:
a furniture component having a working surface and a non-working surface opposite the working surface;
a wireless energy receiver configured to receive energy signals transmitted by the wireless energy transmitter;
an energy storage device electrically coupled to the wireless energy receiver to receive electrical energy therefrom; and
a power output device adapted to transfer energy stored in the energy storage device to an electrical load.

10. An article of furniture as in claim 9, further including an inactivity detector configured to determine an activity status based on an activity signal and an activity signal threshold, the inactivity detector further configured to transmit an activity information to the wireless energy transmitter for preventing the transfer of energy signals based on the activity status.

11. A power distribution system as in claim 10, wherein the activity signal corresponds to at least one of a motion signal, a vibration signal and an illumination signal.

12. An article of furniture as in claim 9, wherein the wireless energy transmitter comprises a laser device and the energy signals comprise a laser beam, wherein the wireless energy receiver comprises a photovoltaic converter receiving the energy signals and providing electrical energy having an first voltage to the energy storage device, and wherein the article of furniture further includes an energy storage device input converter configured to determine an energy storage device voltage and to convert the first voltage to a second voltage based on the energy storage device voltage, the second voltage being higher than the energy storage device voltage.

13. A method of wirelessly powering an article of furniture, the method comprising:
positioning the article of furniture in a first position in a target space, the article of furniture including a wireless energy receiver and the target space including a wireless energy transmitter, wherein in the first position the wireless energy receiver is aligned to receive energy from the wireless energy transmitter;
determining whether the target space is active or inactive;
upon determining that the target space is inactive, transmitting wireless energy signals from the wireless energy transmitter to the wireless energy receiver;
converting the wireless energy signals to electrical energy;
charging an energy storage device supported by the article of furniture with the electrical energy; and
transferring at least a portion of the electrical energy stored in the energy storage device to an electrical load.

14. A method of wirelessly powering an article of furniture as in claim 13, wherein determining that the target space is inactive comprises determining that a current time is within an off-peak period.

15. A method of wirelessly powering an article of furniture as in claim 13, wherein determining that the target space is inactive comprises detecting a signal indicative of activity in the target space and comparing the signal to an activity signal threshold.

16. A method of wirelessly powering an article of furniture as in claim 13, further including sending an information signal to the wireless energy transmitter, the information signal including an inactivity indication.

17. A method of wirelessly powering an article of furniture as in claim 13, further including sending an information signal to the wireless energy transmitter, the information signal including a charge data including an indication of a charge level of the energy storage device.

18. A method of wirelessly powering an article of furniture as in claim 13, further including aligning the remote transmitter and the energy receiver to maximize a transfer of energy between them.

19. A method of wirelessly powering an article of furniture as in claim 13, further including transferring electrical energy from the energy storage device to a second article of furniture.

20. A method of wirelessly powering an article of furniture as in claim 13, further comprising the wireless energy receiver receiving the energy signals and outputting electrical energy having a first voltage, determining an energy storage device voltage, converting the electrical energy output by the wireless energy receiver to electrical energy having a second voltage based on the first voltage and the energy storage device voltage, the second voltage being higher than the energy storage device voltage.
